(19) United States
(12) Patent Application Publication
(10) Pub. No.: US 2008/0097042 A1
(43) Pub. Date: Apr. 24, 2008

(54) Hydroxy-functional copolymerizable polyalkylene glycol macromonomers, their preparation and use

(75) Inventors: Klaus Poellmann, Burghausen (DE); Anton Strasser, Altoetting (DE); Sieglinde Mueller, Burgkirchen (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant International Ltd.

(21) Appl. No.: 11/975,467

(22) Filed: Oct. 19, 2007

(30) Foreign Application Priority Data
Oct. 23, 2006 (DE) 10 2006 049 803.8

(51) Int. Cl. C08G 63/40

(52) U.S. Cl. 525/404

(57) ABSTRACT

The present invention relates to a process for preparing esters of α,β-ethylenically unsaturated carboxylic acids with polyalkylene glycols, by reacting an α,β-ethylenically unsaturated carboxylic acid or reactive derivative thereof with a C₂- to C₄-alkylene oxide or a mixture of such alkylene oxides, wherein this reaction takes place in the presence of from 10 to 10 000 ppm, based on the weight of the α,β-ethylenically unsaturated carboxylic acid used, of either 2,2,6,6-tetramethylpiperidine 1-oxyl or 4-hydroxy-2,2,6,6-tetramethylpiperidine 1-oxyl.

The present invention relates to a process for preparing pure Ω-hydroxypolyalkylene glycols which have, in the a position, an unsaturated conjugated ester group, especially Ω-hydroxymethacryloyl- or Ω-hydroxy-α-acryloylpolyalkylene glycols, and to the use thereof as copolymerizable macromonomers for emulsification, dispersion and steric stabilization of polymers in aqueous systems.

Polyalkylene glycols are prepared on the industrial scale typically by anionic, alkali-catalyzed, ring-opening polymerization of epoxides (ethylene oxide, propylene oxide, butylene oxide) under high pressure and high temperature (see Ullmann Encyclopedia of Industrial Chemistry 5th ed., VCH, ISBN 3-527-20100-9). With alcohols R′—OH as the initiator, for example with methanol, α-methoxy-Ω-hydroxypolyalkylene glycols are thus formed very specifically according to equation 1.

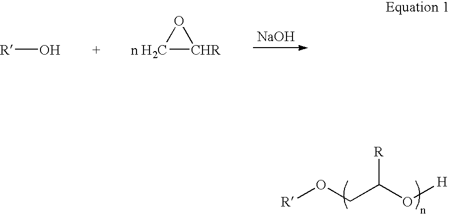

With carboxylic acids as an initiator, a similar reaction according to equation 2 takes place.

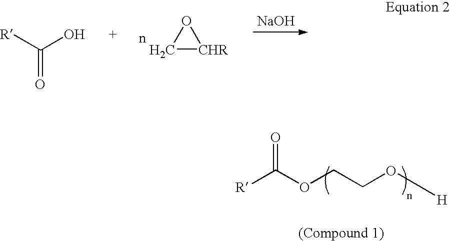

The esters thus formed are, however, in the alkaline reaction medium, subject to a permanent hydrolysis and transesterification reaction according to equation 3, which proceeds in parallel to the ring-opening polymerization and leads to a product mixture of α,Ω-dihydroxypolyalkylene glycols, α,Ω-diesters and the target product (compound 1).

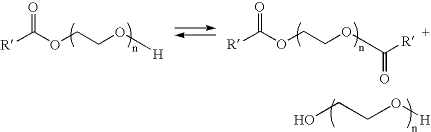

Polyalkylene glycol macromonomers are those polyalkylene glycols which, in addition to the polyether chain, contain a reactive copolymerizable terminal double bond. They are used to prepare so-called comb polymers with polyalkylene glycol side groups (DE-A-100 17 667) or as reactive emulsifiers in emulsion polymerization (EP-A-1 531 933). The Ω-hydroxy-α-allyloxy- or Ω-hydroxy-α-vinyloxy-functional polyalkylene glycol macromonomers described there, however, have the disadvantage that, caused by the unfavorable copolymerization tendency, they cannot be used as hydroxy-functional macromonomers with many common comonomers. More generally usable and therefore significantly more advantageous are Ω-hydroxy-functional polyalkylene glycol macromonomers which, in the α-position, have the ester group of a conjugated unsaturated acid, especially Ω-hydroxy-functional α-methacryloyl- or α-acryloyl-polyalkylene glycol macromonomers. Conjugated unsaturated carboxylic acids and esters are understood to mean compounds having a C═C-double bond in the α,β-position relative to the carbon atom of the carbonyl group, which thus contain the following structural elements:

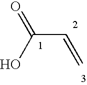

The preparation of those Ω-hydroxy-functional polyalkylene glycol macromonomers which have the ester of a conjugated unsaturated acid in the α,β position in pure form is, however, difficult for two reasons.

Firstly, caused by the transesterification reaction described under equation 3, such macromonomers are not accessible in pure form directly by means of anionic, alkali-catalyzed, ring-opening polymerization of epoxides. Various attempts have therefore been undertaken with non-alkaline catalysts to prepare polyalkylene glycol ester macromonomers (compound 1). In particular, chromium and tin salts (JP-2006-070147, JP-2003 073331, CAS AN 103: 215878), boron trifluoride complexes (U.S. Pat. No. 3,689,532) and Zn complexes (U.S. Pat. No. 6,034,208) have been proposed as catalysts in order to prepare in particular polyalkylene glycol macromonomers proceeding from unsaturated carboxylic acids such as methacrylic acid, acrylic acid or maleic acid (JP-2006-070147). However, it was possible to achieve either only low molar masses, or else the products contained, caused by transesterification reactions which take place according to equation 3, a high proportion of diester with crosslinking action (Ali, Stover, Macromolecules pp. 5219 ff, Vol. 37, 2004).

Secondly, derivatives of conjugated unsaturated acids, especially the acrylic and methacrylic acid derivatives, have a great tendency to homopolymerize, so that the reactions with the alkylene oxides, if at all, can be performed only in the presence of high concentrations of polymerization inhibitors (JP-63284146, JP-2005-281274). According to the prior art, phenolic or aminic polymerization inhibitors, for example hydroquinone, methylhydroquinone, tert-butylhydroquinone, benzoquinone, BHA, p-phenylenediamine or phenothiazine, are used for this purpose. These inhibitors react through their active OH or NH end groups in turn with the epoxides to give other undesired by-products. Frequently, there inhibitor action is also insufficient to completely prevent the polymerization of the conjugated unsaturated acid/ester group completely. Reactions with alkylene oxides therefore afford macromonomers contaminated with high molecular weight polymers which have formed as a result of polymerization on the conjugated unsaturated acid group. Such highly polymerized impurities are discernible by means of gel permeation chromatography (GPC) as component with molar masses greater than 20 000 g/mol.

EP-A-1 012 203 describes the reaction of conjugated unsaturated carboxylic acids and hydroxy esters with alkylene oxides in the presence of so-called DMC catalysts (double metal cyanide catalysts) and specific vinyl polymerization inhibitors such as 1,4-benzoquinone, naphthoquinone or trinitrobenzene, which are, however, not effective enough to completely prevent the polymerization of the conjugated unsaturated acid or ester groups under the conditions of the industrially practicable alkylene oxide polymerization.

In order to prepare α-methacryloyl- or α-acryloylpolyalkylene glycol macromonomers, α-methoxy-Ω-hydroxypolyalkylene glycols (M-PEGs) are therefore frequently prepared first in a complicated two-stage process, and they are converted to their α-methoxy-Ω-methacryloylpolyalkylene glycol esters by esterification with acrylic acid or methacrylic acid (WO-A-00/012 577, EP-A-0 965 605) (equation 4)

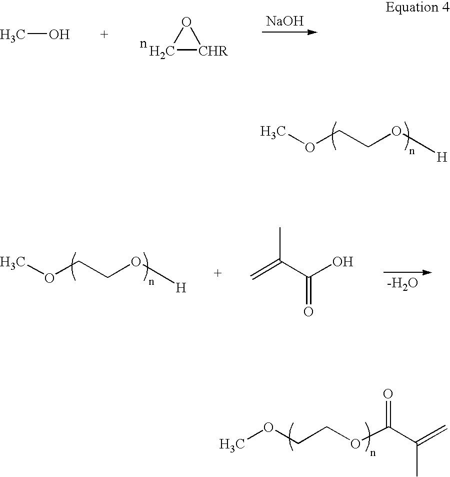

These α-methoxy-Ω-methacryloylpolyalkylene glycol macromonomers do not, however, contain any free hydroxy groups, therefore have less favorable emulsification properties and are, as a result of the terminal unreactive Ω-methoxy group, not amenable to any further reactions.

It was therefore an object of the present invention to find a process for preparing pure Ω-hydroxyl-functional polyalkylene glycol macromonomers which, in the α position, bear the structural unit of a conjugated unsaturated carboxylic ester, especially Ω-hydroxy-α-methacryloyl- or Ω-hydroxy-α-acryloylpolyalkylene glycols, in which a homopolymerization of the conjugated unsaturated group does not take place as a side reaction and in which the hydrolysis and transesterification according to equation 3 does not take place, such that pure linear Ω-hydroxy-α-(meth)acryloylpolyalkylene glycols form. In particular, it was an object of the present invention to prepare linear Ω-hydroxy-α-(meth)acryloylpolyalkylene glycol block copolymers in this manner.

It has been found that, surprisingly, the object is achieved by the preparation of such copolymers in the presence of 10-10 000 ppm of the polymerization inhibitors 2,2,6,6-tetramethylpiperidine 1-oxyl or 4-hydroxy-2,2,6,6-tetramethylpiperidine 1-oxyl.

The invention therefore provides a process for preparing monoesters of α,β-ethylenically unsaturated carboxylic acids with polyalkylene glycols, by reacting an α,β-ethylenically unsaturated carboxylic acid or reactive derivative thereof with a C₂- to C₄-alkylene oxide or a mixture of such alkylene oxides, wherein this reaction takes place in the presence of from 10 to 10 000 ppm, based on the weight of the α,β-ethylenically unsaturated carboxylic acid used, of either 2,2,6,6-tetramethylpiperidine 1-oxyl or 4-hydroxy-2,2,6,6-tetramethylpiperidine 1-oxyl.

The invention further provides compositions which are obtainable by the process according to the invention and contain from 1 to 10 000 ppm of 2,2,6,6-tetramethylpiperidine 1-oxyl or 4-hydroxy-2,2,6,6-tetramethylpiperidine 1-oxyl. It is possible by the process according to the invention to prepare especially the compounds of the following formulae (1) and (2).

The alkylene oxides used are ethylene oxide, propylene oxide or butylene oxide.

The reaction products formed are, in a formal sense, esters formed from carboxylic acids and polyalkylene glycols. In the present context, monoesters shall be understood to mean esters in which only one of the two terminal hydroxyl groups of the polyalkylene groups has been esterified. The term “monoester” does not relate to the carboxylic acid. When it is at least a dicarboxylic acid, it can be diesterified.

When the α,β-ethylenically unsaturated carboxylic acid is a monocarboxylic acid, the products of the process according to the invention correspond preferably to the formula 1

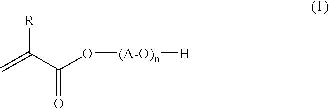

in which
R is hydrogen or methyl,
A is C₂- to C₄-alkylene and
n is from 1 to 500.

When the α,β-ethylenically unsaturated carboxylic acid is a dicarboxylic acid, the products of the process according to the invention correspond preferably to the formula (2)

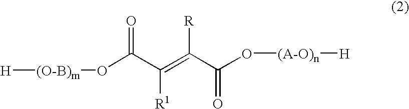

in which
R, R¹ are each independently H or methyl,
A, B are each independently C₂- to C₄-alkylene,
n, m are each independently from 1 to 500.

(A-O)ₙ and (B—O)ₘ may represent mixed alkylene oxide groups in random or block arrangement, or homogeneous alkylene oxide groups. In a preferred embodiment, (A-O)ₙ and/or (B—O)ₘ represent mixed alkoxy groups which contain ethylene oxide and propylene oxide units, the molar proportion of the ethylene oxide units being 50% or more.

n and m are preferably each from 3 to 250, especially from 5 to 200.

Reactive derivatives of α,β-ethylenically unsaturated carboxylic acids are in particular their esters, especially their hydroxyalkyl esters.

Suitable conjugated α,β-unsaturated acids are in particular acrylic acid, methacrylic acid, fumaric acid, maleic acid, itaconic acid. Suitable conjugated unsaturated hydroxyalkyl esters, or hydroxyalkylethoxy and hydroxyalkylpropoxy esters, are in particular hydroxyethyl methacrylate, hydroxypropyl methacrylate, hydroxyethyl acrylate, hydroxypropyl acrylate, diethylene glycol monomethacrylic esters, diethylene glycol monoacrylic esters, dipropylene glycol monomethacrylic esters, dipropylene glycol monoacrylic esters, triethylene glycol monomethacrylic esters, triethylene glycol monoacrylic esters, tripropylene glycol monomethacrylic esters, tripropylene glycol monoacrylic esters.

The inventive polymerization inhibitors 2,2,6,6-tetramethylpiperidine 1-oxyl or 4-hydroxy-2,2,6,6-tetramethylpiperidine 1-oxyl effectively prevent the formation of high polymers by polymerizing the conjugated unsaturated acid/ester group in the reactants and the copolymerizable macromonomers during their preparation by adding-on the alkylene oxides at reaction temperatures of industrial interest of from 80 to 130° C.

In addition to the inventive polymerization inhibitors 2,2,6,6-tetramethylpiperidine 1-oxyl or 4-hydroxy-2,2,6,6-tetramethylpiperidine 1-oxyl, it is also additionally possible for known polymerization inhibitors, especially phenolic or aminic polymerization inhibitors, to be present.

The inventive reaction of the conjugated unsaturated acids or reactive derivatives, such as conjugated unsaturated hydroxyalkyl esters, with alkylene oxides has to be effected in the presence of so-called DMC catalysts (double metal cyanide catalysts). These catalysts have, for example, the formula Zn₃[Co(CN)₆]₂.xZnCl₂.yH₂O.z glyme where x=from 0.2 to 3, y=from 1 to 10 and z=from 0.5 to 10, as disclosed in EP-B-0 555 053. Suitable DMC catalysts are known in the literature, also with other complex ligands. Their preparation and composition is described, inter alia, in EP-A-1 244 519, EP-A-0 761 708, EP-A-654 302 and EP-A-1 276 563. In particular, the DMC catalysts described in example 2 of EP-A-1 276 563 are suitable.

In a preferred embodiment, the alkylene oxides are metered in individually, successively or in a mixture in order to achieve di- or triblock copolymers or block copolymers with different random distribution of the alkylene oxide units in the blocks. The reaction of the mixtures of conjugated unsaturated acids or reactive derivatives thereof with the polymerization inhibitors and the alkylene oxides is effected under customary reaction conditions of an industrial alkoxylation, i.e. in the temperature range from 80 to 150° C., preferably from 100 to 130° C., and pressures between 2 and 20 bar, under nitrogen, optionally in the presence of inert aprotic solvents, for example toluene, xylene or THF.

The molar masses of the inventive reaction products, such as Ω-hydroxy-α-methacryloyl- or Ω-hydroxy-α-acryloylpolyalkylene glycol macromonomers or of the corresponding mixtures with the polymerization inhibitors, can be determined by means of determining the OH number (to DIN 53240, determination of the number-average Mn) and by GPC analysis with PEG calibration (determination of the molar mass distribution). The molar mass is generally between 500 and 10 000 g/mol, preferably between 750 and 7000 g/mol. The ratio of conjugated unsaturated-carboxylic acid to propylene oxide, ethylene oxide units and hydroxyl end groups in the macromonomer can be determined by means of NMR spectroscopy. What is crucial is the fact that the use of the inventive mixtures of the polymerization inhibitors 2,2,6,6-tetramethylpiperidine 1-oxyl or 4-hydroxy-2,2,6,6-tetramethylpiperidine 1-oxyl and the corresponding conjugated unsaturated acids or hydroxyalkyl esters as initiators of the alkylene oxide polymerization does not form any polymers of the conjugated unsaturated acids or hydroxyalkyl esters and does not give rise to any α,Ω-diester polyalkylene glycols. These undesired polymers would be manifested in GPC analysis by a very high molecular weight content with molar masses of >10 000 g/mol, and also in NMR spectroscopy by a significant deficiency of conjugated double bonds in relation to the end hydroxyl groups and the stoichiometric use amounts of ethylene oxide and propylene oxide (see comparative example 1).

The inventive reaction products, especially the mixtures of the compounds of the formulae 1 and 2 with from 10 to 10 000 ppm of the polymerization inhibitors 2,2,6,6-tetramethylpiperidine 1-oxyl or 4-hydroxy-2,2,6,6-tetramethylpiperidine 1-oxyl, can be copolymerized with a multitude of free-radically polymerizable monomers, for example styrene, vinyl acetate, acrylic acid, methacrylic acid and alkyl esters thereof, in bulk and aqueous solution, by using common initiators of free-radical polymerization. The resulting comb polymers with polyalkylene side chains are stabilized sterically by the polyalkylene glycol side chains and thus form stable aqueous polymer dispersions.

The invention and applications thereof will now be illustrated further with reference to examples.

### EXAMPLE 1

A 1 l pressure reactor is initially charged with 0.625 mol (90 g) of hydroxypropyl methacrylate and 0.045 g of 2,2,6,6-tetramethylpiperidine 1-oxyl and 0.045 g of the DMC catalyst described in EP-A-1 276 563. The mixture is heated to a temperature of 110° C. under nitrogen, and an amount of 72.5 g of propylene oxide is metered in at a pressure of about 3 bar such that the heat of reaction which arises can be removed. Once the propylene oxide has been depleted, recognizable by a pressure drop, 560 g of ethylene oxide are now metered in such that the heat of reaction which arises can be removed. After the depletion, recognizable by a pressure drop to the starting pressure, the product is analyzed by means of OH number titration, NMR spectroscopy and GPC molar mass determination.

| OH | Calculated | NMR molar | |
|---|---|---|---|
| number | molar | ratio from | |
| in mg | mass Mn | ¹H NMR signals | |
| KOH/g to | from OH | Double | GPC characterization |
| DIN | number in | bond | (lipophilic GPC in THF with |
| 53240 | g/mol | methacryloyl:PO:EO:CH₂OH | PEG calibration standards) |
| 50.6 | 1109 | 1:2.9:20:1.07 | A main peak > 92% with |
| | | | maximum at 1100 g/mol; no |
| | | | polymer fractions with molar |
| | | | masses above 2500 g/mol |

A methacrylic ester-(PO)₃(EO)₂₀—OH block copolymer has thus formed.

### EXAMPLE 2

A 1 l pressure reactor is initially charged with 0.625 mol (90 g) of hydroxypropyl methacrylate and 0.045 g of 2,2,6,6-tetramethylpiperidine 1-oxyl and 0.045 g of the DMC catalyst described in EP-A-1 276 563. The mixture is heated to a temperature of 120° C. under nitrogen, and an amount of 72.5 g of propylene oxide is metered in at a pressure of about 3 bar such that the heat of reaction which arises can be removed. Once the propylene oxide has been depleted, recognizable by a pressure drop, 560 g of ethylene oxide are now metered in such that the heat of reaction which arises can be removed. After the depletion, recognizable by a pressure drop to the starting pressure, the product is analyzed by means of OH number titration, NMR spectroscopy and GPC molar mass determination.

| | | NMR molar | GPC |
|---|---|---|---|
| | Calculated | ratio from ¹H | characterization |
| | molar mass | NMR signals | (lipophilic GPC in |
| OH number in mg | Mn from OH | Double | THF with PEG |
| KOH/g to | number in | bond | calibration |
| DIN 53240 | g/mol | methacryloyl:PO:EO:CH₂OH | standards) |
| 50.6 | 1109 | 1:2.9:20:1.07 | A main peak > 92% |
| | | | with maximum at |
| | | | 1100 g/mol; no |
| | | | polymer fractions |
| | | | with molar masses |
| | | | above 2500 g/mol |

A methacrylic ester-(PO)₃(EO)₂₀—OH block copolymer has thus formed. Highly polymerized fractions with molar masses of >10 000 g/mol, as would arise by polymerization of the conjugated double bond of the methacrylic acid group, are not present.

### EXAMPLE 3

A 3.1 pressure reactor is initially charged with 1 mol (144 g) of hydroxypropyl methacrylate and 0.05 g of 2,2,6,6-tetramethylpiperidine 1-oxyl and 0.15 g of the DMC catalyst described in EP-A-1 276 563. The mixture is heated to a temperature of 100° C. under nitrogen, and an amount of 58 g of propylene oxide is metered in at a pressure of about 3 bar such that the heat of reaction which arises can be removed. Once the propylene oxide has been depleted, recognizable by a pressure drop, 1994 g of ethylene oxide are now metered in such that the heat of reaction which arises can be removed. After the depletion, recognizable by a pressure drop to the starting pressure, the product is analyzed by means of OH number titration, NMR spectroscopy and GPC molar mass determination.

| | | NMR | |
|---|---|---|---|
| OH | Calculated | molar ratio from | |
| number in | molar mass | ¹H NMR signals | GPC characterization |
| mg KOH/g | Mn from OH | Double | (lipophilic GPC in THF |
| to | number in | bond | with PEG calibration |
| DIN 53240 | g/mol | methacryloyl:PO:EO:CH₂OH | standards) |
| 28.8 | 1947 | 1:2.1:37:1.15 | A main peak > 90% |
| | | | with maximum at |
| | | | approx. 1700 g/mol; no |
| | | | polymer fractions with |
| | | | molar masses above |
| | | | 3000 g/mol |

A methacrylic ester-(PO)₂(EO)₃₇—OH block copolymer has thus formed. Highly polymerized fractions with molar masses of >10 000 g/mol, as would arise by polymerization of the conjugated double bond of the methacrylic acid group, are not present.

### EXAMPLE 4

A 1 l pressure reactor is initially charged with 1 mol (130 g) of hydroxyethyl methacrylate and 0.1 g of 2,2,6,6-tetramethylpiperidine 1-oxyl and 0.2 g of the DMC catalyst described in EP-A-1 276 563. The mixture is heated to a temperature of 120° C. under nitrogen, and an amount of 232 g of propylene oxide is metered in at a pressure of about 2 bar such that the heat of reaction which arises can be removed. Once the propylene oxide has been depleted, recognizable by a pressure drop, 510 g of a mixture of ethylene oxide and propylene oxide in a molar ratio of 1:1 are now metered in such that the heat of reaction which arises can be removed. After the depletion, recognizable by a pressure drop to the starting pressure, the product is analyzed by means of OH number titration, NMR spectroscopy and GPC molar mass determination.

| | | NMR molar | |
|---|---|---|---|
| | Calculated | ratio from | |
| OH number | molar mass | ¹H NMR signals | GPC characterization |
| in mg | Mn from | Double | (lipophilic GPC |
| KOH/g to | OH number | bond | in THF with PEG |
| DIN 53240 | in g/mol | methacryloyl:PO:EO:CH₂OH | calibration standards) |
| 69 | 810 | 1:8.9:6:1.03 | A main peak > 93% with |
| | | | maximum at approx. |
| | | | 780 g/mol; no polymer |
| | | | fractions with molar |
| | | | masses above 2000 g/mol |

A methacrylic ester-(EO)(PO)₄(random EO-PO)₅—OH block copolymer has thus formed. Highly polymerized fractions with molar masses of >10 000 g/mol, as would arise by polymerization of the conjugated double bond of the methacrylic acid group, are not present.

### EXAMPLE 5

The macromonomer from example 1 is used as a coemulsifier in the emulsion polymerization of n-butyl acrylate, methyl methacrylate and methacrylic acid in aqueous liquor. The copolymer of butyl acrylate, methyl methacrylate, methacrylic acid and the product from example 1 which forms in situ has good emulsion-stabilizing properties.

500 ml of deionized water are initially charged in a glass flask, and 15 g of sodium alkylsulfate, 15 g of 3.75% ammonium peroxodisulfate solution, 11.5 g of n-butyl acrylate, 11.8 g of methyl methacrylate and 0.48 g of methacrylic acid are added, and the mixture is stirred and heated to 80° C. under nitrogen. Over a period of 4 hours, a monomer emulsion which consists of 470 ml of water, 16 g of sodium alkylsulfonate, 8 g of the product from example 1,440 g of n-butyl acrylate, 440 g of methyl methacrylate, 8.8 g of methacrylic acid and 2.85 g of ammonium peroxodisulfate is metered in under nitrogen. On completion of metered addition of the monomer emulsion and continued polymerization of one hour at 80° C., the polymer dispersion is cooled and adjusted to a neutral pH.

The copolymer of butyl acrylate, methyl methacrylate, methacrylic acid and the product from example 1 which forms in situ is a stable aqueous polymer dispersion.

### EXAMPLE 6

The macromonomer from example 2 is used as a coemulsifier in the emulsion polymerization of a styrene/acrylate dispersion.

To this end, a monomer solution (1) composed of 332 ml of deionized water, 4.8 g of sodium alkylsulfate, 15 g of the product from example 2, 3.6 g of sodium hydrogencarbonate, 216 g of styrene, 300 g of n-butyl acrylate, 144 g of methyl acrylate and 6.6 g of methacrylic acid is prepared. An initiator solution (2) composed of 3.33 g of ammonium peroxodisulfate and 85.5 ml of deionized water is likewise prepared.

204 g of deionized water are initially charged in a 2 liter reaction vessel, and 6.6 g of the product from example 2 are added. Under a nitrogen atmosphere with stirring, the mixture is heated to 80° C., then 22 ml of the initiator solution (2) and 25 ml of the monomer solution are added, and the emulsion polymerization is thus started. At a reaction temperature of 80° C., the residual monomer solution (1) and the initiator solution (2) are metered in with cooling within 3 hours. Subsequently, the mixture is heated for one further hour and the product is neutralized to pH 6 to 8. This forms a stable polymer dispersion with a solids content of 50%.

### COMPARATIVE EXAMPLE 1

A 31 pressure reactor is initially charged with 1 mol (144 g) of hydroxypropyl methacrylate and 0.03 g of hydroquinone monomethyl ether, and also 1.2 g of benzoquinone and 0.2 g of the DMC catalyst described in EP-A-1 276 563. The mixture is heated to a temperature of 110° C. under nitrogen, and an amount of 58 g of propylene oxide is metered in at a pressure of about 2 bar such that the heat of reaction which arises can be removed. Once the propylene oxide has been depleted, recognizable by a pressure drop, 1994 g of ethylene oxide are now metered in such that the heat of reaction which arises can be removed. After the depletion, recognizable by a pressure drop to the starting pressure, the product is analyzed by means of OH number titration, NMR spectroscopy and GPC molar mass determination.

| | | NMR molar ratio | |
|---|---|---|---|
| | Calculated | from ¹H NMR | |
| OH number | molar mass | signals | GPC characterization |
| in mg | Mn from OH | Double | (lipophilic GPC in THF |
| KOH/g to | number in | bond | with PEG calibration |
| DIN 53240 | g/mol | methacryloyl:PO:EO:CH₂OH | standards) |
| 37.2 | 1550 | 1:1.7:30:1.17 | A 68% peak with |
| | | | maximum at approx. |
| | | | 1500 g/mol, a 22% peak |
| | | | with maximum |
| | | | 4000 g/mol, an approx. |
| | | | 10% peak with molar |
| | | | masses above |
| | | | 10 000 g/mol |

The target product has formed only in a small portion (68%). In addition, undesired high molecular weight impurities with molar masses of >4000 and >10 000 g/mol are present.

1. A process for preparing a monoester of an α,β-ethylenically unsaturated carboxylic acid with a polyalkylene glycol, said process comprising reacting in an alkoxylation reaction an α,β-ethylenically unsaturated carboxylic acid or reactive derivative thereof with a C₂- to C₄-alkylene oxide or a mixture of C₂- to C₄-alkylene oxides, wherein said reacting taking place in the presence of from 10 to 10 000 ppm, based on the weight of the α,β-ethylenically unsaturated carboxylic acid of either 2,2,6,6-tetramethylpiperidine 1-oxyl or 4-hydroxy-2,2,6,6-tetramethylpiperidine 1-oxyl.

2. The process as claimed in claim 1, wherein the monoester of an α,β-ethylenically unsaturated carboxylic acid corresponds to the formula 1 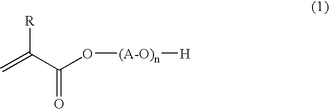
in which
R is hydrogen or methyl,
A is C₂- to C₄-alkylene and
n is from 1 to 500.

3. The process as claimed in claim 1, wherein the monoester of an α,β-ethylenically unsaturated carboxylic acid corresponds to the formula 2 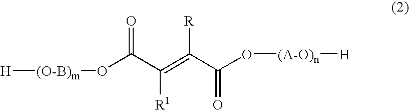
in which
R, R¹ are each independently H or methyl,
A, B are each independently C₂- to C₄-alkylene,
n, m are each independently from 1 to 500.

4. The process of claim 3, wherein n and m are each independently from 3 to 250.

5. The process of claim 1 in which the alkoxylation reaction is performed with a mixture of ethylene oxide and propylene oxide or successively with ethylene oxide and propylene oxide in any sequence, so that the monoester of an α,β-ethylenically unsaturated carboxylic acid comprises a mixed alkylene oxide group which is arranged randomly or blockwise and contains comprises at least 50 mol % of ethylene oxide groups.

6. The process of claim 1 in which the α,β-ethylenically unsaturated carboxylic acid or reactive derivative thereof is acrylic acid, methacrylic acid or a monoester thereof with mono-, di-, triethylene glycol or mono-, di-, tripropylene glycol or butylene glycol.

7. The process of claim 1, wherein the α,β-ethylenically unsaturated carboxylic acid or reactive derivative thereof is selected from the group consisting of fumaric acid, maleic acid, itaconic acid or diesters thereof with mono-, di-, triethylene glycol or mono-, di-, tripropylene glycol or butylene glycol.

8. The process of claim 1, which is performed in the presence of a DMC catalyst.

9. A composition obtained by the process of claim 1.

10. A method for inhibiting in an alkoxylation reaction of an α,β-ethylenically unsaturated carboxylic acid or reactive derivative thereof with an alkylene oxide or a mixture of alkylene oxides in the presence of a DMC catalyst, said method comprising adding to the alkoxylation reaction from 10 to 10 000 ppm of 2,2,6,6-tetramethylpiperidine 1-oxyl or 4-hydroxy-2,2,6,6-tetramethylpiperidine 1-oxyl.

11. (canceled)

12. (canceled)

13. (canceled)

14. The process of claim 3, wherein n and m are each independently from 5 to 200.
